(19) United States
(12) Patent Application Publication
(10) Pub. No.: US 2011/0250813 A1
(43) Pub. Date: Oct. 13, 2011

(54) NON-WOVEN FABRIC COMPOSITES FROM COIR FIBERS

(75) Inventors: Walter BRADLEY, Woodway, TX (US); David Stanton Greer, Hewitt, TX (US)

(73) Assignee: BAYLOR UNIVERSITY, Waco, TX (US)

(21) Appl. No.: 13/161,316

(22) Filed: Jun. 15, 2011

Related U.S. Application Data
(63) Continuation of application No. 12/574,518, filed on Oct. 6, 2009.
(60) Provisional application No. 61/103,173, filed on Oct. 6, 2008.
(60) Provisional application No. 61/176,422, filed on May 7, 2009.

(51) Int. Cl. D04H 5/00; B27N 3/12; D04H 1/48

(52) U.S. Cl. 442/341; 442/411; 442/334; 442/405; 264/257

(57) ABSTRACT

A non-woven fabric composite containing coir fibers and a method for producing such composites. The non-woven fabric composite is comprised of coir fibers, which are large diameter, lignin-rich fibers, with a high viscous flow temperature and a high degradation temperature combined with fibers made of a thermoplastic polymer with a lower viscous flow temperature such as polypropylene, polyethylene or a biodegradable thermoplastic polymer fiber such as polylactic acid, or mixture thereof. A hot-pressed non-woven fabric composite material prepared from the non-woven fabric composite.

The present invention claims priority to U.S. patent application Ser. No. 12/574,518, filed on Oct. 6, 2009, which claims the benefit of U.S. Provisional Patent Application No. 61/103,173, filed Oct. 6, 2008, and U.S. Provisional Patent Application No. 61/176,422 filed May 7, 2009, the entire content of which is hereby incorporated by reference.

### BACKGROUND

The present invention pertains to a non-woven fabric composite material, its manufacture and its uses. More specifically, it relates to a non-woven fabric composite materials containing coir fibers that are rich in lignin, with large diameters, combined with fibers made from a thermoplastic polymer such as polypropylene and including fibers that are made from polymers biodegradable.

German Patent DE 19711247 to Mieck and Reussmann describes a process for the production of long fiber granulates from hybrid bands. This process involves moving flax and hemp hybrid bands through a 200° C. preheated zone, and pulling the material through a heated nozzle, followed by cooling.

German Patent DE 4440246 to Michels and Meister describes a process for production of a fiber reinforced composite with at least a thermoplastic polymer as matrix material, and cellulose fibers or filaments as reinforcing material.

U.S. Pat. No. 5,948,712 to Tanabe describes a fabric comprising a stiff fiber and a thermoplastic fiber. The fabric is made by heating the stiff fiber and thermoplastic fiber at ambient pressure, followed by compression molding at ambient temperature. The resulting fabric would tear under any substantial force, however, and the two-step process for producing it is expensive.

German Patent DE 19934377 to Bayer and Koine describes a process for producing a polyester-strengthened polypropylene compounds, and involves a polypropylene material with a natural material such as Jute, flax, hemp, or recycled cellulose.

German Patent DE 10052693 to Kitsayama and Yoshinori describes laminate and materials with natural fiber content with focus on automobile interiors. A process is described which involves mixing a material with a weight of 150 g/cm² with Jute fibers and propylene fibers, followed by needle punching, and baking of the resulting material at 180 C. This process, however, is expensive, and results in a heart of thermoplastic material rather than an equal distribution of materials.

United States Patent Publication 2006/0099393 describes a composite thermoplastic sheets including natural fibers, wherein the sheet material comprises discontinuous fibers bonded by thermoplastic resin.

German Patent DE 10151761 to Mueller et al. describes a process for production of semi-finished fiber strengthened thermoplastics for high load construction materials. A process for producing thermoplastic materials is described wherein a material comprising thermoplastic matrix and long fibers is pulled through pots to orient the fibers within the matrix. The material is subsequently heated using infrared radiation.

United States Patent Publication 2007/0116923 describes a fiber reinforced thermoplastic resin molding, wherein the fiber comprises linen fiber which is spun into yarns.

German Patent Publication DE 102004054228 to Wittig and Retzlaff describes methods and preparations for production of a group part-binding/forming natural fiber materials to man-made materials. This publication describes an improved method for forming a natural fiber to a separate functional piece which is man-made, using a glue and specially designed openings in each piece.

Coconuts are an abundant, renewable resource in countries within 20° of the equator. The coconuts, or coco-nuts, develop inside a husk that provides protection to the nut. The nut is widely used to produce coconut oil from the white coconut meat, called copra, as seen in FIG. 1. Approximately 50% of the biomass in the husk is in the form of fibers, which are typically called coir or coir fibers. The husk is often discarded as trash and burned, polluting the atmosphere with greenhouse gases and other contaminates. Replacing petroleum based fibers with natural fibers like coir from coconut husks rather than burning the husks makes this new invention very environmentally friendly.

One of the largest applications for the current invention of non-woven fabric composite materials is for parts for automobiles. Non-woven fabric composite materials for trunk liners, floor mats, door panels, dash boards and other parts of automobiles are currently made by combining fibers like polyester with a higher viscous flow temperature with fibers with a lower viscous flow temperature like polypropylene. Both fibers are derived from petroleum. The present invention involves replacing some or all petroleum-based fibers with the higher viscous flow temperature in the non-woven fabric composite material with a lignin-rich natural fiber like coir fiber that is less expensive, makes the composite more sustainable and environmentally friendly, and provides suitable and in some cases superior physical and mechanical properties to the PP:PET composites that are now used. The non-woven fabric composite felted material made by combining large diameter, lignin-rich natural fibers like coir blended with fibers made from thermoplastics such as polypropylene or polyethylene can be compression molded into automotive parts using the same dies and processing equipment (approximately same temperatures and pressures that are currently used for PP:PET felted material) that is currently used to make parts for automobiles, making possible a seamless, barrier free entry into the marketplace for non-woven fabric composites for automobile parts using the invention described herein. This should also be true for many other industries where the current invention can be utilized.

A humanitarian benefit of this invention is that it will create a demand for coir fiber, giving their husks that are now usually burned some value, and thus will provide additional income to the 11 million very poor coconut farmers, many of whom subsist on less than a few hundred U.S. dollars of income per year.

A further environmental benefit of the current invention is that it will “utilize” the coir fiber which is abundant in certain parts of the world and avoid discarding and burning as waste the coconut husks from which the fibers are extracted.

### SUMMARY

One aspect of the present invention pertains to non-woven fabric composites containing coir fibers and a method for producing such composites. The non-woven fabric composite may be comprised of coir fibers, which are large diameter, lignin-rich fibers, with a higher viscous flow temperature and degradation temperature and fibers made of a thermoplastic polymer with a lower viscous flow temperature such as polypropylene or a biodegradable thermoplastic polymer fiber such as polylactic acid. The processing window for hot pressing this composite is above the viscous flow temperature of the thermoplastic and the lower of the degradation temperature or the viscous flow temperature of the coir fiber.

An example of the method to be used for hot pressing coir fiber and polypropylene requires the following steps: (1) removing the natural fibers called coir, which has a relatively high degradation temperature from the coconut husk; (2) securing thermoplastic fibers made from recycled polypropylene that has a lower viscous flow temperature than the degradation temperature of coir; (3) cutting the fibers to 25-75 mm length but preferably 50-75 mm lengths; (4) blending the milled 50-75 mm coir fibers with the polypropylene fibers to form a very flexible non-woven fabric material felt (or non-woven fabric material mat); and depending on the application (4) hot pressing the flexible non-woven fabric material felt at elevated temperatures above the viscous flow temperature (or melt temperature) of the polyproplyene fibers, using a die or a flat platen press to form rigid parts with a desired shape or a flat panel.

### BRIEF DESCRIPTION OF THE DRAWINGS

The patent or application file contains at least one drawing executed in color. Copies of this patent or patent application publication with color drawings(s) will be provided by the Office upon request and payment of the necessary fee.

The following drawings form part of the present specification and are included to further demonstrate certain aspects of the present invention. The invention may be better understood by reference to one or more of these drawings in combination with the detailed description of specific embodiments presented herein.

FIG. 1 shows an open coconut and husk with fibers, usually called coir fibers.

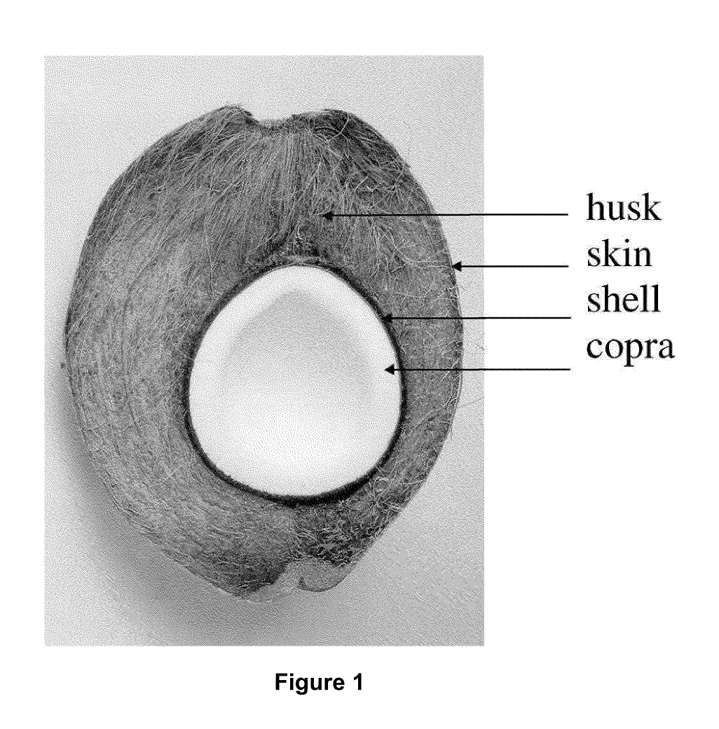

FIG. 2 shows opened coconut husk with coconut, a portion of the husk and long coir fibers that may be milled into approximately 50-75 mm lengths to be processed into felted material in accordance with the present invention.

FIG. 3 shows short coir fibers (upper left) and short polypropylene fibers (lower left) prior to being blended, carded and needle punched into felted material (right) in accordance with the present invention.

FIG. 4 shows felt comprised of 50% polyester/50% polypropylene fiber matting which is widely used at present (left) and felt comprised of coir fiber/polypropylene fiber (right) in accordance with the present invention.

FIG. 5 shows felted material comprised of 50 wt % coir fiber and 50 wt % polypropylene fiber prior to hot pressing (which is the same as compression molding at elevated temperature), as seen at 10× (left) and 40× (right).

FIG. 6 shows non-woven fabric composite material made from polyester fiber and polypropylene fibers (left) and non-woven fabric composite material made from coir fiber and polypropylene fibers (right) with each plaque produced by hot pressing the respective felted materials at about 207° C. and about 150 psi of pressure.

FIG. 7 shows the difference in hot pressing a non-woven fabric composite material felt at 180° C. (left) and at 220° C. (right), indicating the dramatic difference 40° C. can make in the flow of the PP fiber and the degree of wetting of the coir fiber by the PP.

FIG. 8 shows a hot pressed door panel (top), a hot pressed trunk liner (middle), and a polyester/propylene non-woven fabric composite material felt (bottom) prior to hot pressing. One aspect of this invention would substitute coir fibers for polyester fibers in such parts.

FIG. 9 shows tensile strength as a function of density for non-woven fabric composite materials after hot pressing, using various combinations of temperature and pressure to achieve the range of densities.

FIG. 10 shows flexural modulus as a function of density for non-woven fabric composite materials after hot pressing, using various combinations of temperature and pressure to achieve the range of densities.

### DETAILED DESCRIPTION OF PREFERRED EMBODIMENTS

### Definitions

The term “natural fiber” as used herein, refers to any continuous filament which is derived from a natural, renewable sources such as plants or animals. The words “fiber” and “fibers” are used interchangeably. Natural fibers may include, but are not limited to, seed fibers such as cotton and kapok; leaf fibers such as sisal and agave; bast fiber or skin fiber such as flax, jute, kenaf, hemp, ramie, rattan, soybean fiber, vine fibers, and banana fibers; fruit fiber such as coconut fiber; stalk fiber such as straws of wheat, rice, barley, bamboo, grass, and tree wood; animal hair fiber such as sheep's wool, goat hair (cashmere, mohair), alpaca hair, horse hair; silk fiber; avian fiber such as feathers; Preferably, the natural fiber used in this invention should possess at least moderate strength and stiffness and good ductility. It should also have sufficient adhesion to the lower melting point fiber, or be surface treatable to increase chemical compatibility and provide adequate adhesion between the natural fiber and the thermoplastic fibers. Natural fibers that are rich in lignin are especially desirable, preferably with a lignin content of greater than about 20 wt %. Fibers with larger diameters are also preferable to give greater fiber stiffness and lower density felted material and lower density parts pressed from the felted material.

The phrase “coir fiber” as used herein refers to any type of fiber derived from the coconut husk of the coconut palm tree, Cocos nucifera.

The phrases “fiber with a higher viscous flow temperature” and “fiber with a lower viscous flow temperature” as used herein, refer to the temperatures at which the viscosity of the respective fibers reach a suitably low value that viscous flow occurs relatively easily. The degradation temperature for fibers is the temperature at which the fiber begins to oxidize and degrade. This will not be a unique temperature but will depend on the time at temperature, with a shorter time at the elevated temperature resulting in a somewhat higher degradation temperature and a longer time at temperature resulting in a lower degradation temperature. The processing window for hot pressing the non-woven fabric composites defined in this invention will be between the viscous flow temperature for the thermoplastic fibers (which must have a lower viscous flow temperature than the natural fiber) and the lower of either the degradation temperature or the viscous flow temperature of the natural fiber. Generally, the processing window for hot pressing the non-woven fabric composites made using natural and thermoplastic fibers will have the upper bound for processing being the degradation temperature of the natural fiber (which is usually lower for natural fibers than the temperature at which viscous flow occurs easily) and the lower bound will depend on the viscous flow temperature of the thermoplastic, where sufficient flow of these thermoplastic fibers to “bond” to the natural fibers will be take place under a given pressure.

The phrase “non-woven fabric composite material” as used herein refer to any material comprising two or more fibers that are neither woven nor knitted, that is to say fibers that have been blended and laid into a matted form with the fibers randomly oriented in the mat, or felt as it usually called. The 50-75 mm long fibers are bonded together by chemical, mechanical, pressure at elevated temperature without any surface treatment or pressure and temperature applied after surface treatments to enhance adhesion between the two types of fibers. The composite can exist in two forms: a very flexible felt (or mat) and a more rigid form that is produced by hot pressing (or compression molding). The non-woven fabric composite should not be confused with conventional fiber reinforced plastic composites that are comprised of a continuous matrix of polymer with discontinuous fibers reinforcing the plastic. The non-woven fabric composite consists of a blending of two or more types of fibers rather than a mixing of one fiber type in a viscous polymer melt that is subsequently cooled to a solid plastic reinforced with fibers.

The term “thermoplastic polymer fiber” as used herein, refers to any fiber comprising a polymer which is easily formed at higher temperatures because its viscosity decreases monotonically with increasing temperature, and rapidly above the melt temperature. By contrast, thermosetting polymers chemical react when heated and cannot be easily formed subsequently. For purposes of this invention, thermoplastic polymers include, but are not limited to, polypropylene (“PP”), polyethylene (“PE”), and polylactic acid (“PLA”).

The ratios of fibers that are given in this patent are in weight fractions. Therefore a ratio of 50:50 of Fiber A to Fiber B in a mixture would indicate that 50% of the total mass in the mixture consists of Fiber A, and 50% of the total mass in the mixture consists of Fiber B. The range of weight ratios in this invention go from 20:80 to 95:5 coir fiber to thermoplastic fiber. The higher the coir fiber, the lower will be the density of the non-woven fabric composite material felt and the lower will be the density of the non-woven fabric composite material after it has been hot pressed into the shape of a part.

In one preferred embodiment of the non-woven fabric composite material designed for manufacturing into higher density, more rigid parts by hot pressing (or other high temperature forming processes that convert felted material into rigid material), the present invention pertains to a non-woven fabric composite comprised of (1) a natural fiber with a relatively higher viscous flow temperature and/or biodegradation temperature than that of the thermoplastic fiber, matted together at around room temperature; and (2) a thermoplastic fiber with a lower viscous flow temperature, preferably made from recycled material or a thermoplastic fiber that is a biodegradable fiber. In preferred embodiments, the natural fibers may comprise lignin rich natural fibers with relatively larger diameters such as coir fibers, and the thermoplastic fibers may be a polypropylene (“PP”) or a polyethylene (“PE”) or biodegradable fibers such as polylactic acid (“PLA”), or mixtures thereof Such composites can be used in automobile parts and other products such as those made by elevated temperature compression molding. In a second preferred embodiment where the non-woven fabric composite is to be used in a low density, soft, flexible form, and therefore, does not need to be hot pressed into a rigid part, a large diameter fiber rich in lignin such as coir fiber can be used by itself or with a small additions (5-30%) of any other fiber (does not need to be a thermoplastic, but can be a polyester fiber such as PET), but preferably one with a small diameter to facilitate the processing, and more preferably a second natural fiber to make the non-woven fabric composite more environmentally friendly. Flexible non-woven fabric composites as described in this second embodiment can be used for such applications as insulation, cushioning in packaging or for padding in children's toys.

Natural fibers that are rich in lignin have some distinctive physical and mechanical properties that can be extremely beneficial in particular applications. First, lignin rich fibers do not burn as rapidly as natural fibers that are richer in cellulose. Second, lignin rich fibers are less susceptible to developing odors due to molds and other microbials. Third, lignin rich fibers are more durable when exposed to water. Coir fiber is a lignin rich fiber with 33 wt % lignin compared, for example, to flax (2.8 wt %), sisal (10 wt %), jute (12 wt %), kenaf (15 wt %) or cotton (15 wt %).

Fibers that have larger diameters also have advantages for some applications of non-woven fabric composite materials. Fibers with larger diameters will be stiffer in bending and have more resilience. They will also process differently into non-woven fabrics, giving lower density felted material due to the fiber stiffness than non-woven fabric made with fibers that are all smaller diameter. After hot pressing, non-woven fabrics made with a mixture that includes some larger diameter fibers will also have a much lower density than non-wovens made entirely with small diameter fibers.

Coir fibers also have much larger average diameters than do most natural or synthetic fibers, with diameters ranging from ˜150 μm to about 500 μm compared to most natural or synthetic fibers that have diameters of ˜40 μm. Coir fibers also have attractive mechanical properties including an elongation of ˜15-20% compared to most natural fibers with an elongation of 1-2%.

The lignin-rich fibers (e.g., coir fiber) can be incorporated into two kinds of non-woven fabric composites: (1) those that will be produced and used as a non-woven fabric composite material in felted or matted form, which is soft and flexible and (2) those that will be produced as non-woven fabric composite material in felted form but will subsequently be molded at elevated temperatures into more rigid parts or panels.

For non-woven fabric composite materials that will be molded at elevated temperatures into more rigid parts, the second type of fiber that is blended with the lignin rich natural fiber must have a viscous flow temperature (sometimes called a melt temperature) that is less than the temperature at which the natural fiber degrades, and this degradation temperature depends on the length of time the fibers are at maximum molding temperature during processing. Higher molding temperatures can be tolerated for a shorter time and lower molding temperature can be tolerated for longer time. Fibers made from polypropylene, polyethylene or copolymers of the two monomers flow at temperatures below the degradation of lignin-rich natural fibers such as coir. Furthermore, there is a large supply of these fibers that are made from recycled material. When lignin-rich fibers such as coir are combined with polypropylene fibers made from recycled material as they are in this invention, the resultant non-woven fabric composite materials are very environmentally friendly indeed.

### I Non-Woven Fabric Composite Material Utilizing Coir Fibers

In a preferred embodiment, the invention comprises a non-woven fabric composite material which includes a blend of at least two types of fibers, one fiber with a higher degradation temperature or viscous flow temperature and the other fiber with a lower viscous flow temperature. The fiber with the higher viscous flow or degradation temperature will be a natural fiber, preferably a coir fiber, and can be physically mixed (such as in a hopper) with some higher temperature viscous flow thermoplastic fiber such as “PET,” or polyester fiber. The fiber with the lower viscous flow temperature can be a thermoplastic fiber, such as polypropylene (“PP”), polyethylene (“PE”), polylactic acid (“PLA”), or mixture thereof. Thus, the non-woven fabric composite material could include a mixture of coir fibers, PP and PET.

The lengths of the natural fibers and the thermoplastic fibers can vary from about 10 mm to 100 mm, preferably from about 25 mm to about 75 mm. Also, preferably, the natural fibers and the thermoplastic fibers have approximately the same length. The thermoplastic fiber can have a diameter of from about 30 μm to about 50 μm.

Different types of fibers can be made to cohere in a felt, or matted together, by the following methods:
Thermal bonding
   Using a large oven for curing
   Calendering through heated rollers (called spunbond when combined with spunlaid), calendars can be smooth faced for an overall bond or patterned for a softer, more tear resistant bond.
Hydro-entanglement: mechanical intertwining of fibers by water jets (called spunlace)
Ultrasonic pattern bonding, often used in high-loft or fabric insulation/quilts/bedding
Needled felt or needle punched felt: mechanical intertwining of fibers by needles pushing fibers that are layed in the plane of the felt through the thickness of the felt, increase the cohesion of the fibers in the felt
chemical bonding (wetlaid process): use of binders (such as latex emulsion or solution polymers) to chemically join the fibers. A more expensive route uses binder fibers or powders that soften and melt to hold other non-melting fibers together
one type of cotton staple nonwoven is treated with sodium hydroxide to shrink bond the mat, the caustic causes the cellulose-based fibers to curl and shrink around one another as the bonding technique
meltblown or air carding randomly laying two or more types of fibers that are very weakly bonded from the air attenuated fibers intertangling with themselves during web formation as well as the temporary tackiness they have as they laid randomly into a matted or felted material
one unusual polyamide spunbond (Cerex) is self-bonded with gas-phase acid.

There are four preferred means for making two or more types of fibers cohere in this invention of non-woven fabric composite materials. First, the non-woven fibers can be laid randomly into a loose mat where the fibers all lie in parallel planes. Needle punching will then bend some of the fibers and push them partially or totally through the thickness of the mat, making the mat more cohesive, giving it very modest tensile strength but high flexibility for handling purposes and making it easy to compression mold. Such matted material is also suitable for insulation, padding and other applications where low strength and low density are desired. The fibers in this process are not truly bonded but just mechanically entangled sufficiently to perform as a “quasi-mechanical bonding”. A second way to join the fibers that also gives weak bonding between fibers, again with low strength and density, is using various adhesives that may be sprayed during air carding of fibers, making them “tacky” and giving very weak attachment between fibers, again making the matted or felted material low in strength but with high flexibility, good for insulation, padding and other similar applications. A third way that the fibers can be joined that results in much higher strengths and stiffnesses, making rigid parts, is hot pressing that causes the thermoplastic fiber to locally melt and flow, wetting adjacent natural fibers, effectively “gluing” the whole fibers network together into a rigid web, giving significant strength and stiffness to the hot pressed part. A fourth approach gives the highest strength and stiffness to the non-woven fabric composite by enhancing the adhesion between the natural and the thermoplastic fibers. This can be done by using chemical cleaning of the natural fiber, for example removing the waxy coating that is present on coir fibers, and by using chemical compatibilizers to treat the natural or thermoplastic fibers; for example using maleic anhydride to make graft copolymer with polypropylene, since the maleic anhydride can chemically react to form strong bonding to a cleaned coir fiber (but not a coir fiber with waxy coating), giving an interfacial strength that is three times that observed for polypropylene and coir fibers that have not been cleaned. The felted material must still be hot pressed to achieve this high tensile strength and stiffness, as the flow of the thermoplastic is essential to increase the interfacial bonding area between the two fibers.

The non-woven fabric composite of this invention can be made with various combinations of fibers, areal densities and weight percentages of each fiber, depending on the application and the specific family of physical and mechanical properties that are desired. For automotive applications, for example, trunk liners are less stiff, door panels are moderately stiff, and dashboards require the greatest stiffness.

For non-woven fabric composite materials that will not be hot pressed (e.g., building insulation, cushioning for packaging), it is not necessary to use a thermoplastic fiber at all and the degradation temperature of the natural fiber is less critical since no elevated temperature processing is required.

### II Method for Producing a Non-Woven Fabric Composite Material Utilizing Coir Fibers

In a further preferred embodiment, the invention comprises a method for producing a non-woven fabric composite material utilizing fiber with a higher viscous flow temperature and a fiber with a lower viscous flow temperature. The higher melting point fiber is a larger diameter preferably lignin-rich, natural fiber, more preferably coir fiber.

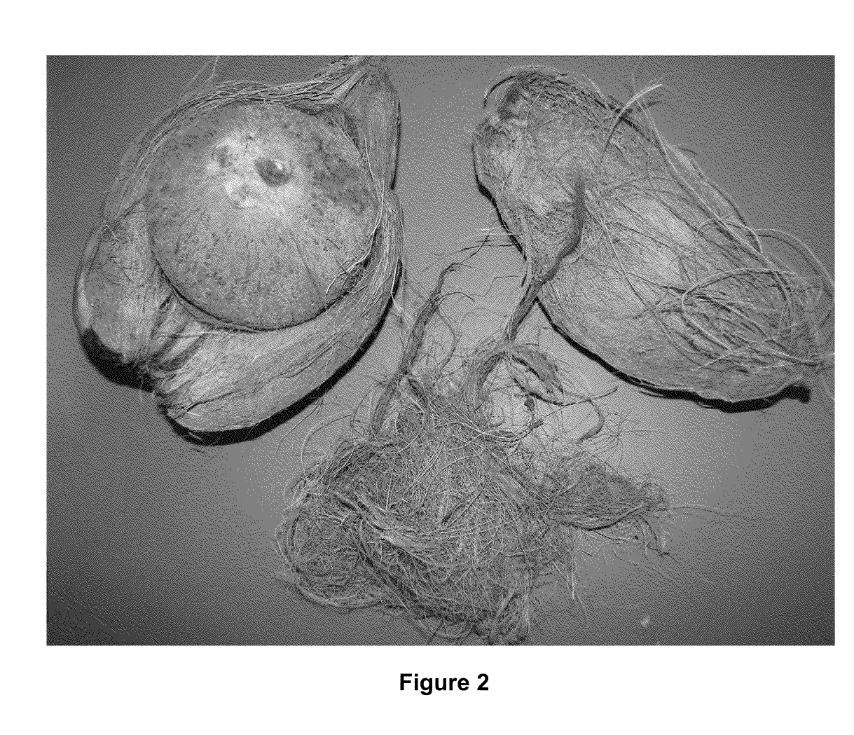

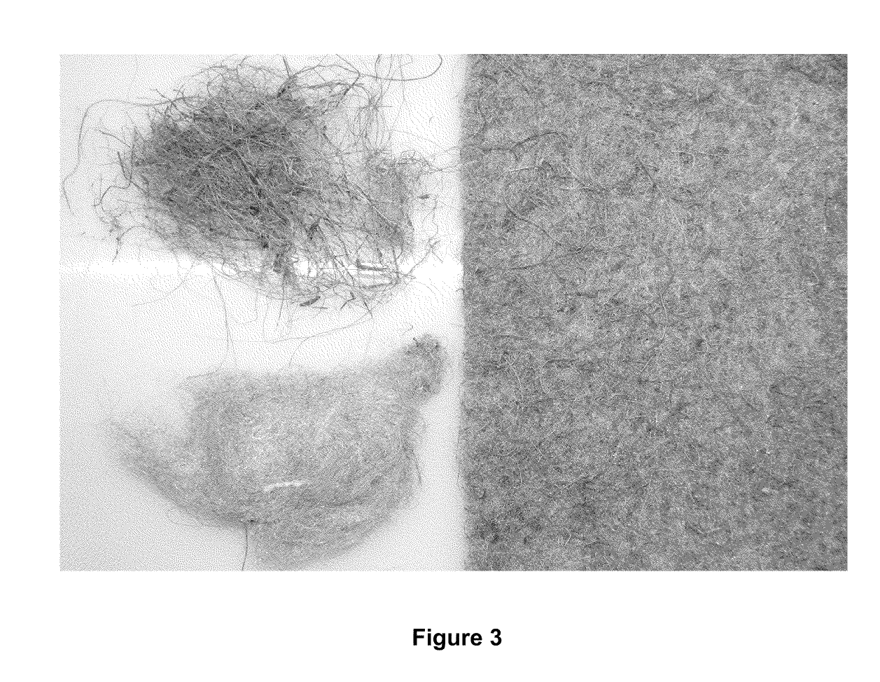

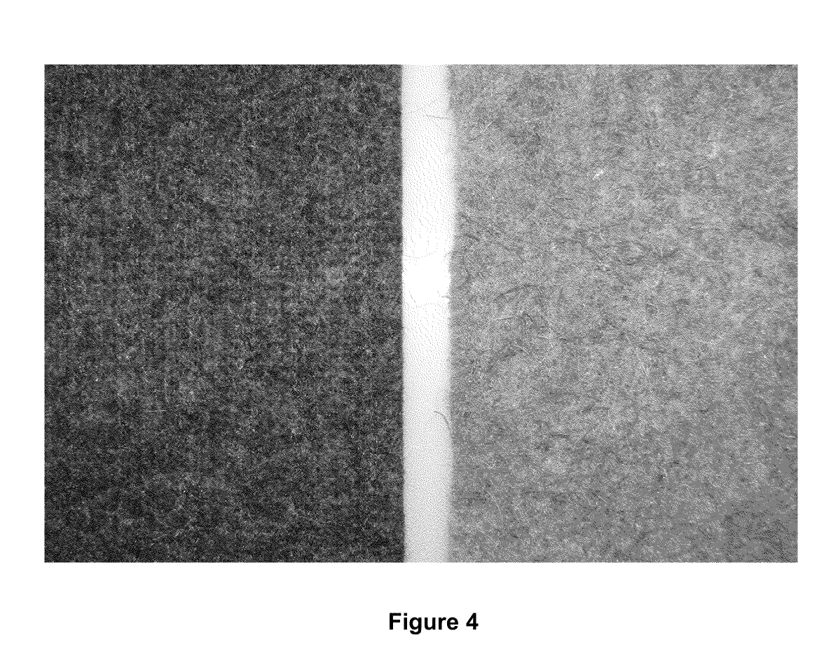

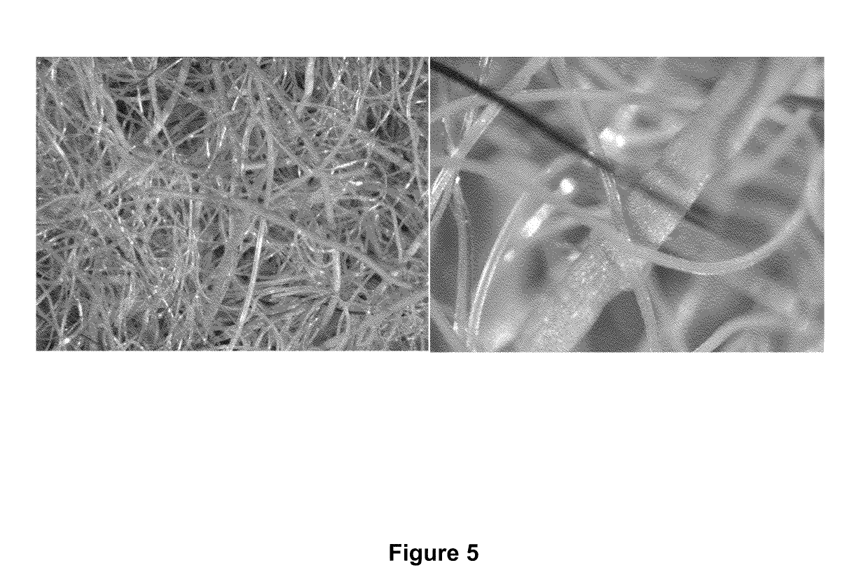

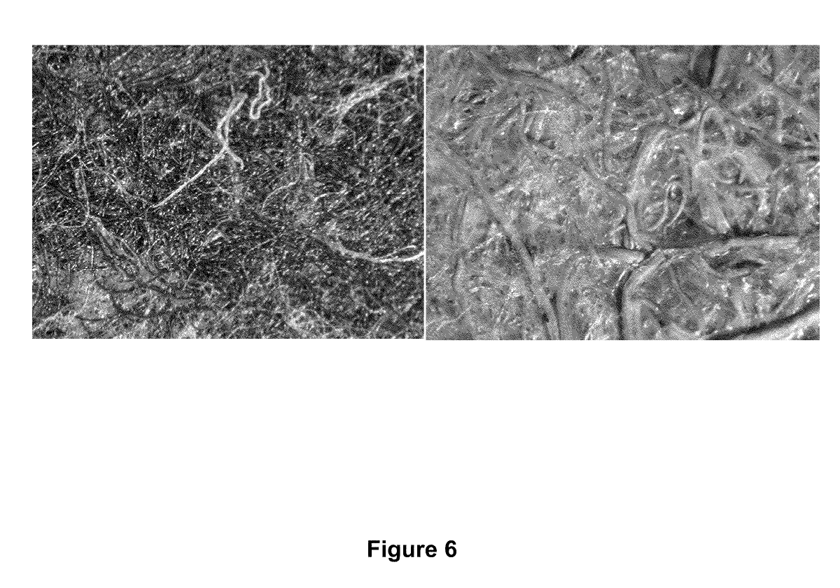

The method comprises the steps of: (1) obtaining a natural fiber (see FIG. 2) with a sufficiently high viscous flow temperature and degradation temperature and suitable combination of stiffness, strength, and ductility; (2) mill the higher melting point natural fiber to a desired fiber length determined by the processing equipment to be used to make the felted material subsequently, which was 50-75 mm in the carding and needle punching equipment used in developing this invention (FIG. 3); (3) mixing this milled natural fiber, which has a higher viscous flow temperature, with a thermoplastic fiber that has been cut to similar lengths and that has a lower viscous flow temperature; (4) create a matted (or felted) material (FIGS. 4 and 5) from the blended fibers using carding and needle punching, air carding with light adhesives as previously described, or other suitable processes; and if so desired, (5) hot pressing the felted material using a die (to give the desired shape to the part) in a compression molding machine with the felted material at a suitable temperature and pressure so that the non-woven fabric composite assumes the rigid shape needed for a particular part (FIG. 6).

The most critical parameter for hot pressing non-woven fabric composite material felt into rigid parts is the pressing temperature. When PP sheet is shaped using thermoforming, it is generally formed at temperatures between 165° C. and 180° C., since the PP used is an isotactic, semi-crystalline polymer whose crystalline regions melt in this temperature range. Viscous flow can only occur easily in semi-crystalline PP when the crystals melt, and this occurs between 165° C. and 180° C. in various isotactic PP. In fact, the viscosity of PP drops by a factor of 500 between 170° C. and 180° C., with the properties changing from a stiff, rubbery solid to a viscous liquid³. If one presses at too low a temperature, the crystals make permanent shape changes (via permanent viscous deformation) difficult to produce. If one presses at too high a temperature (generally thought to be >180° C. in the literature), the resulting low viscosity allows considerable sagging. Therefore, one might assume this temperature range to be optimal for compression molding of non-woven fabric composite material felt with polypropylene fibers as the lower viscous flow temperature constituent. Surprisingly, this has proven to not be the case.

The appropriate temperature and pressure for compression molding a non-woven fabric composite material felt made of coir fibers and polypropylene fibers depends on the application and the combination of mechanical and physical properties that best serve the application. For some applications where thermal insulation or sound damping are required, the felt may be used directly without hot pressing and the felt can be very high in coir fiber content (80:20 to 95:5), with the fiber blended in with the coir fiber also being a natural fiber, with a lower diameter (<80 μm is preferred) to facilitate processing into felted material. Some packaging applications where energy absorption during impact is the primary function might also use coir rich felt with a density of ˜0.15 g/cm³ without hot pressing it, which increases the density of the non-woven fabric composite material. Energy absorption during impact, thermal insulation properties (i.e., low thermal conductivity) and sound damping characteristics (i.e., low sound transmission coefficient) are all optimized at low densities, preferably with non-woven fabric composite felt that has not been hot pressed into a more dense and rigid material, giving mechanical properties that are minimal but unnecessary for this family of applications. The large fiber diameter of the coir fiber give great resilience to insulation, minimizing packing and settling over time, which allows the insulation to maintain its “R” value. R is calculated as insulation thickness divided by the thermal conductivity of the insulation.

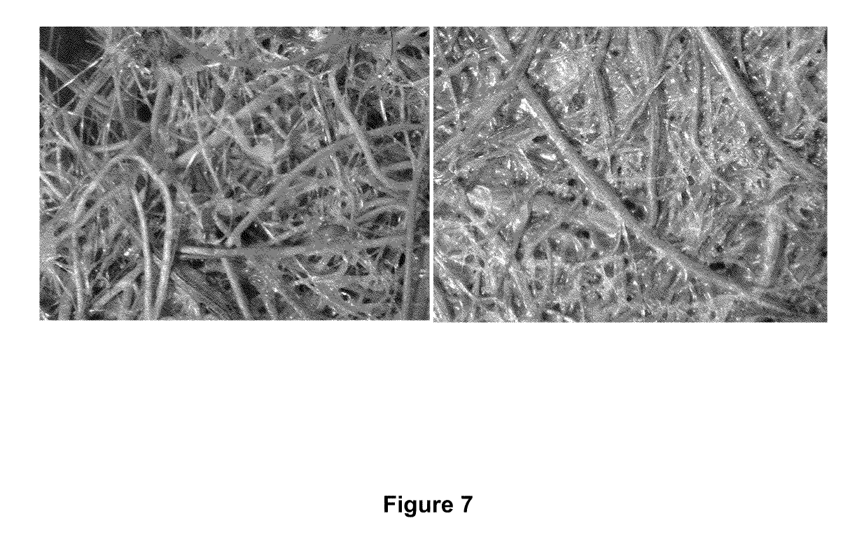

To achieve improved mechanical properties, the non-woven fabric composite felted material needs to be hot pressed or compression molded to both increase the density (more fibers per square centimeter to support the load) and securely attach the coir and polypropylene fibers in the felt to each other (by increasing the contact area where two fibers are being “bonded” as previously described), forming a strong web. As the pressing temperature is increased from 180° C. to around 240° C. and the pressure is increased from 25 psi to 300 psi or more, the density of the compression molded felt increases from about 0.3 g/cm³ to 0.7 g/cm³ or more. It should be noted that a temperature higher than the 170°-180° C. temperature range often used for thermoforming polypropylene sheet is necessary to get sufficient flow of the polypropylene fibers to securely attach the fibers, creating a rigid web. The difference in the flow of the polypropylene and coir fibers and the wetting of the coconut fibers by the polypropylene fiber as it flows is seen in FIG. 7. Heating the non-woven fabric composite felted material to 180° C. without the application of pressure will produce insufficient flow of the polypropylene (or to the melt temperature of whatever thermoplastic fiber is used to “glue” the fiber network together) to give strong joints where the thermoplastic fibers overlay the natural fibers, giving insufficient strength and stiffness. In summary heating the non-woven fabric composite felt material to 180° C. without pressure is unnecessary for applications where a low density felt is desired and inadequate for higher density applications where a more rigid part with better tensile strength and stiffness is required.

In all preferred embodiment, the natural fiber has a larger diameter (most of fibers above 100 μm) and with a higher lignin content (>20%), more preferably coir fiber.

In a preferred embodiments for non-woven fabric composites that will be hot pressed, the fiber with the lower viscous flow temperature is a thermoplastic fiber, preferably a petroleum-based polymer fiber, most preferably polypropylene (PP).

### EXAMPLE 1

The first example is for compression molded parts of a non-woven fabric composite material that utilizes a coir fiber that is rich in lignin and a thermoplastic with a viscous flow temperature that is significantly lower than the degradation temperature of the natural fiber.

### Production of Non-Woven Fabric Composite Material Felt

The natural fibers, specifically coir fibers, and thermoplastic fibers are cut to lengths that depend on the equipment that is to be used to make the non-woven fabric composite material felt, typically lengths between 25 mm and 75 mm. These two types of fibers are blended together into a mixture of coir fibers and thermoplastic fibers. The ratio of coir fibers to thermoplastic fibers might be 50:50 by weight, but can range from 20:80 to 95:05 depending on the combination of mechanical properties needed. The non-woven fabric composite material in the form of a felt (or mat) can be made from the blended fibers using carding and needle punching to bind the carded layers together or air carding, using a lightly sprayed adhesive to bond the fibers together. The felt can be produced in widths of up to 1.5-2.0 m (or more depending on the equipment used) and in any lengths that are that are convenient for shipping. For example, 2 m wide by 3 m long mats might be produced, stacked on skids and shrink wrapped for shipping. Alternatively, rolls of a convenient size for shipping (for example, 1.5 m wide by 100 m long) can be made and shrink wrapped for shipping. Because the fibers are only held together by needle punching or very light adhesive, the felt of non-woven fabric composite material made in these ways is very flexible, allowing it to be produced in rolls suitable for shipping, and more importantly, with the necessary flexibility to assume the shape of the mold when subsequently hot pressed at elevated temperatures between the viscous flow temperature of the thermoplastic fiber and the degradation temperature of the coir fiber. It is important to note that the fibers are not heated during production of the non-woven fabric composite felt (unless a very modest heating is used is used to cure spray adhesives or adhesives applied in some other way to make the fibers tacky instead of using needle punching to give the felt some coherence). It should be noted that heating the felted material to the melt temperatures of the thermoplastic fibers in the absence of pressure to increase bonding between fibers to enhance the cohesion of the felt is unnecessary, will reduce the flexibility of the felt, and will incur unnecessary costs in processing. The bulk density of the non-woven fabric composite felt after needle punching will typically be between 0.1 and 0.2 g/cm³ prior to hot pressing. A finishing cloth can be added to the felted material to produce parts that are more aesthetically pleasing after subsequent hot pressing felt into rigid parts at elevated temperatures. The finishing cloth is typically ˜200 g/m² and should not be degraded at the temperature the felt is subsequently compression molded since it is typically pure polyester.

Compression Molding of Non-Woven Fabric Composite Material into Parts

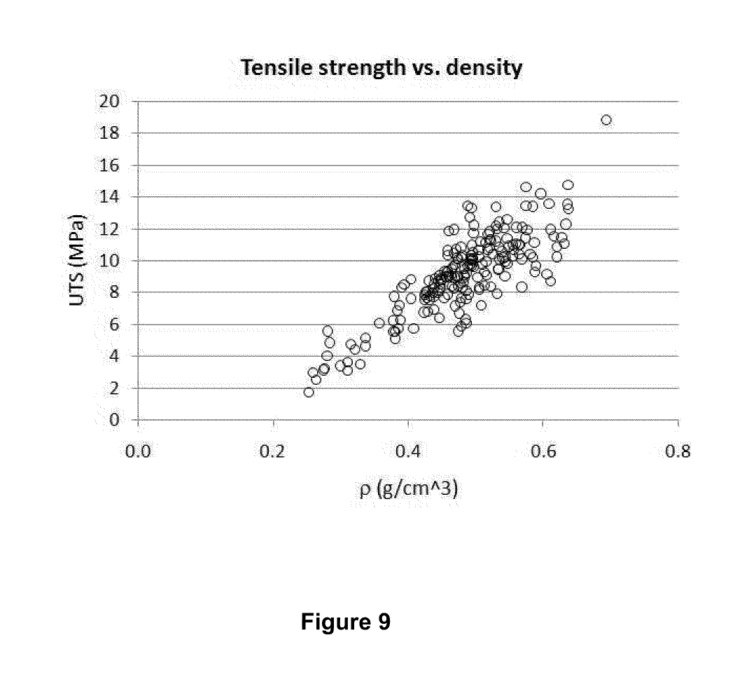

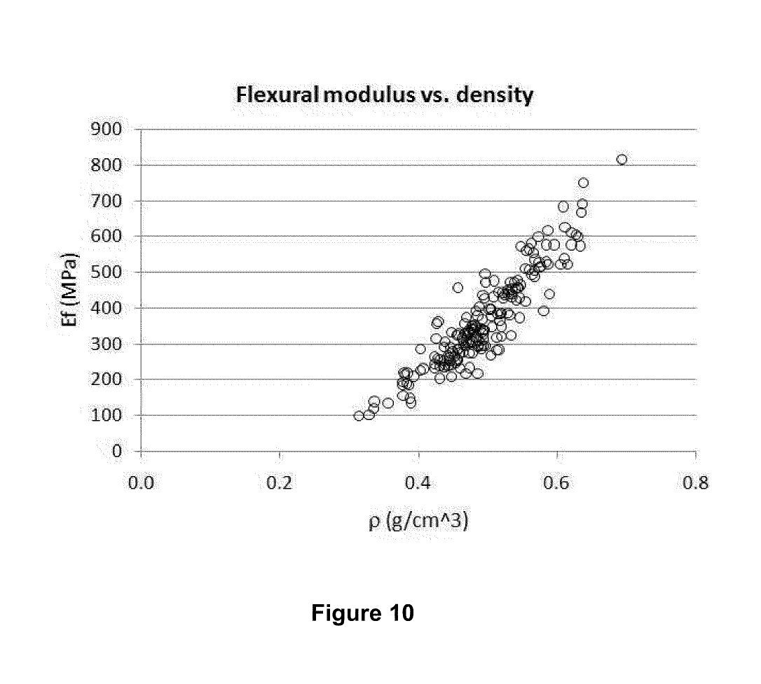

Pieces of felt of non-woven fabric composite material of suitable sizes are subsequently cut from the roll and heated to a suitable temperature, which is greater than the temperature at which the thermoplastic fiber readily manifest viscous flow (>180° C. for polypropylene) but less than the degradation temperature of the natural fiber (which is ˜240° C. for coir fiber depending, on the time at temperature) and hot pressed into the desired shape using a suitable die. Heating to 180° C. in the absence of pressure will produce insufficient flow of the polypropylene fibers to increase the density or attach the randomly oriented unwoven fibers into a rigid network. Thus, for example, for coir fibers blended with polypropylene fibers, the temperature ranges from about 180° C. to about 240° C. Preferably from above 180° to about 240° The compression molding pressure can range from about 25 psi to about 400 psi or more. The particular combination of temperature and pressure used depends on the hot pressed density that is desired to give a particular family of physical and mechanical properties. The density of the compression molded non-woven fabric composite parts will typically be between 0.3 and 0.7 gm/cm³ depending on the combination of temperature, pressure and time at pressure used in processings. The mechanical, thermal and acoustic properties will all vary significantly with density, allowing the properties to be tailored to the needs of a specific application by choosing suitable processing conditions, as seen in FIGS. 9 and 10. For example, automobile trunk liners might be made with non-woven fabric composite materials of coir and polypropylene fibers in a felt with an areal density of 1000 g/m² that has subsequently been compression molded to a thickness of 2 mm and a density of 0.5 g/cm³. Dashboards for automobiles might be made with non-woven fabric composite felt of coir and polypropylene fibers with an areal density of 2000 g/m² that has been compression molded to a thickness of 3.4 mm and a bulk density of 0.6 g/cm³, depending on the specific design and the combination of physical and mechanical properties that are desired. If desirable, industrial coloring agents or dyes can be added in the manufacturing process of the thermoplastic fiber to give a certain color to non-woven fabric composite material felt.

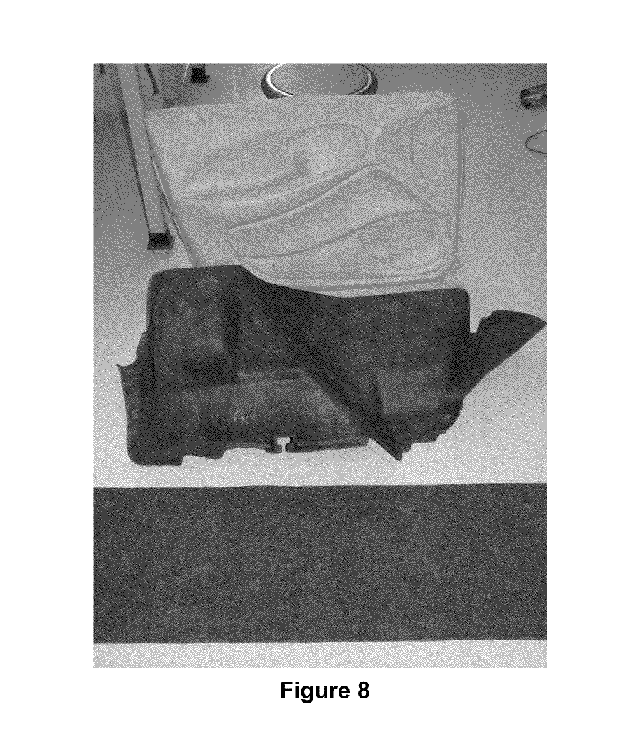

The preferred large diameter, natural fiber rich in lignin is coir fiber, and the preferred thermoplastic fiber is polypropylene for automotive trunk liners. These two fibers can be blended, produced as a non-woven fabric that is then needle punched to increase coherence of the non-woven fabric composite material felt as described above. It can subsequently be hot pressed at a suitable temperature and pressure into a wide variety of products for automobiles (e.g., trunk liners, door panels, dashboards, head liners, package carriers, floor boards, mud flaps etc.) and other products produced by hot pressing non-woven fabric composite such as interiors for truck and tractor cabs, or toys for children. Automobile parts that have been hot pressed from non-woven fabric composite material felt are seen in FIG. 8.

### EXAMPLE 2

The second example is for products that can be made from (1-12.5 mm or possibly thicker) rigid sheets of non-woven fabric composite material using large diameter natural fibers that are rich in lignin (e.g., coir fiber) combined with thermoplastic fibers (e.g., polypropylene).

The non-woven fabric composite felt is made from large diameter, natural fibers, rich in lignin like coir and thermoplastics fibers like polypropylene, which has a viscous flow temperature well below the degradation temperature of the coir fibers using the processes described in Example 1. The non-woven fabric composite material felt (or mat) made from coir fibers and thermoplastic fibers can be pressed into flat, rigid sheets (as distinct from more complex shapes made in compression molding) using a combination of pressure and temperature to get the density that will give the desired combination of mechanical and physical properties, as previously described.

The flat, non-woven fabric composite sheets can be used for building materials such as wall panels, ceiling panels, furniture and other applications requiring a light-weight composite with moderate strength and stiffness and/or low sound transmission coefficient, and low thermal conductivity.

### EXAMPLE 3

The third example is for products that can be made from non-woven fabric composite material felt that has been made using large diameter, natural fibers rich in lignin (e.g., coir fiber) but where the felt will not be processed at elevated temperatures and pressures to make rigid composites like those described by Examples 1 and 2.

The non-woven fabric composite felt is made primarily (>80%) from a large diameter, natural fibers rich in lignin. The felt can be made of 100% natural fiber rich in lignin (e.g., coir fiber) if it is air carded with the fibers held together by sprayed on adhesive. If the non-woven fabric composite is made of lignin rich, large diameter (150-500 um) fibers like coir fibers, the felt can be produced by carding and needle punching but may require 0-20% natural fibers with smaller diameters (˜40 um) such as kenaf that are more flexible and will easily be bent during needle punching to penetrate through the thickness, giving cohesiveness to the felt. The felt need not include thermoplastic fibers since for these applications, hot pressing to give a high density rigid material as is done in Examples 1 and 2 is undesirable. A smaller amount (˜5%) of a third type of fiber that is a thermoplastic might be included to melt and then cohere the two natural fibers together, which would require heating to the temperature required to melt the third type of fiber, but not hot pressing.

In this application, the emphasis is on products that require a very low thermal conductivity, a low sound transmission coefficient, and/or a high level of cushioning for energy absorption. These properties are achieved for woven fabric composite materials that are very low density; namely, felt that will not be subsequently processed at higher temperatures and pressures into a higher density, rigid material.

Applications for non-woven fabric composites of primarily (or exclusively) large diameter natural fibers that are rich in lignin like coir include building/housing insulation, packing for packaging and under-the-hood applications in automotive.

### EXAMPLE 4

One application of this patent is composite materials for the automotive industry. In particular, trunk liners, truck decking, truck lid liners, door panels and floor mats are all potential applications can be made as described in what follows. Each part may require different strength and stiffness, and thus, need slightly different percentages of the two fibers (20:80 to 80:20) used and different hot pressing temperatures (200° C.-230° C.) to achieve the distinctive properties required. This versatility is another benefit of this invention.

In this example, natural coir fibers are combined with petroleum based polypropylene (PP) fibers (FIG. 3) in a blending process that results in a matt of blended but unwoven coir and PP fibers (FIG. 3) with an areal density of 1000 g/cm².

The coir fiber is limited to a hot pressing temperature of about 240° C. depending on pressing time by oxidative degradation. The polypropylene fiber has the lower viscous flow temperature, with its viscosity dropping dramatically by 500× between 170° C. and 180° C. as the crystals in this semi-crystalline polymer melt. As previously noted, 180° C. or less is the usual thermoforming (or hot pressing) temperature for sheet polypropylene. This temperature limit is due to sag issues in PP sheet above 180° C. However, as previously explained, this temperature is too low to make PP:coir non-woven fabric composites with suitable combinations of strength and stiffness, since at 180° C., there is relatively little flow of the PP fibers, as seen in FIG. 7 with flow at 220° C. shown for comparison. Note that at 180° C. without any pressure, there would be very little flow of the polypropylene fibers necessary to firmly join the coir fibers into a rigid web.

For this application, it is necessary that the PP's viscosity be sufficiently low, not just to allow the PP fibers to flow under at a modest pressure of 100 to 150 psi. Furthermore, the flow of the PP fibers needs to be sufficient to wet the coir fiber to effectively “glue” the coir fibers together to create a web structure, with moderate strength and stiffness. The degree of flow can be increased by increasing the hot pressing temperature, as seen in FIG. 7, where the degree of flow of the PP at 180° C. may be compared to the degree of flow of the PP at 220° C. The strength and stiffness of the specimen hot pressed at 180° C. is much less than the one pressed at 220° C. (see FIG. 7). In commercial production, the matted material seen in FIG. 4 and FIG. 8 (strip across bottom) is pressed into automotive parts like the trunk liner and the door panel presented in FIG. 8. The matted material is heated to the specified hot pressing temperature in a furnace and then placed into a hot pressing unit with dies to create the desired shape for the part. Usually the die surfaces are also heated, but to a lower temperature than the specified hot pressing temperature to facilitate more rapid cooling and reduced cycle times. The heated material can also be pressed in a cold mold.

A thin, non-woven finishing fabric made with only one type of fiber that has a higher viscous flow temperature than the hot pressing temperature to be used can be attached with stitching to the matted fiber blend, as seen in FIG. 4. During hot pressing this woven fabric is unaffected, but becomes even more securely attached to the hot pressed composite due to flow of the PP at the interface between the finishing fabric and the composite backing The resulting panel is moderately stiff with an attractive fabric finish so that the hot formed part is ready to be installed into an automobile without further processing.

### REFERENCES CITED

The following references, to the extent that they provide exemplary procedural or other details supplementary to those set forth herein, are specifically incorporated herein by reference.

### U.S. Patent Documents

U.S. Pat. No. 6,939,903 issued on Sep. 6, 2005, with Sigworth et al. list^{e}d as inventors.
U.S. Pat. No. 6,682,673 issued on Jan. 27, 2004, with Skwiercz listed as the inventor.
U.S. Pat. No. 6,648,363 issued on Nov. 18, 2003, with Gordon listed as the inventor.
U.S. Pat. No. 5,948,712 issued on Sep. 7, 1999, with Tanab^{e et} al. listed as inventors.
U.S. Pat. No. 5,709,925 issued on Jan. 20, 1998 with Spengler et al. listed as inventors.
U.S. Pat. No. 5,976,646 issued on Nov. 2, 1999, with Stevens et al. listed as inventors.
U.S. Patent Publication No. 2008/0081188 issued on Apr. 3, 2008, with Chang et al. listed as inventors.
U.S. Patent Publication No. 2007/0116923 published on May 24, 2007, with Kasuya et al. listed as inventors.
U.S. Patent Publication No. 2004/0185239 published on Sep. 23, 2004, with Nakamura et al. listed as inventors.

### Non-Patent Documents

1. Polymer Data Handbook., Editor: Mark, James E. (New York: Oxford University Press), 1999.
2. Polymer Handbook, 4^{th} Edition, Editors: J. Brandrup, E. H. Immergut, E. A. Grulke. (New York: John Wiley & Sons, Inc), 1999.
3. Throne, Jim, “Let's Thermoform Polypropylene”, A Technical Minute. Copyright 2007: Sherwood Technologies. throne@foammandform.com.
4. Parikh, D. V. et al. “Thermoformable automotive composites containing kenaf and other cellulosic fibers” Textile Research Journal, August 2002.

1. A non-woven fabric composite material, comprising:
coir fiber; and
a fiber made from or including a synthetic thermoplastic polymer,
wherein the synthetic thermoplastic polymer is selected from the group consisting of polypropylene, polyethylene, polylactic acid, and mixtures thereof,
wherein the coir fiber and the fiber made from the synthetic thermoplastic polymer are matted together to form a matted material,
wherein the coir fiber has a higher viscous flow temperature and a higher degradation temperature than that of the fiber made from the synthetic thermoplastic polymer, and
wherein the matted material has been heated to a temperature throughout the matted material that is higher than the melt temperature of the fiber made from or including the synthetic thermoplastic polymer but less than the degradation temperature of the coir fiber and hot pressed at that temperature at a compression pressure range of 25 psi or more.

2. The non-woven fabric composite material of claim 1, wherein the length of the coir fiber and the fiber made from the synthetic thermoplastic polymer is from 10 mm to 100 mm.

3. The non-woven fabric composite material of claim 1, wherein the diameter of the coir fiber is from 150 μm to 500 μm.

4. The non-woven fabric composite material of claim 1, wherein the coir fiber and the fiber made from the synthetic thermoplastic polymer are matted together using carding and needle punching, cyclone air deposition, chemical, heat, or solvent treatment.

5. The non-woven fabric composite material of claim 1, wherein the weight ratio of the coir fiber to the fiber made from the synthetic thermoplastic polymer is from 95:5 to 20:80.

6. The non-woven fabric composite material of claim 1, wherein the synthetic thermoplastic polymer is polypropylene, and wherein the matted material has been heated to a temperature throughout the matted material above 180° C.

7. The non-woven fabric composite material of claim 1, wherein the fiber made from the synthetic thermoplastic polymer comprises polypropylene and wherein the matted material has been heated to a temperature throughout the matted material above 180° C. and lower than 240° C.

8. The non-woven fabric composite material of claim 1, wherein the matted material has been heated to a temperature throughout the matted material between 200° C. and 230° C. and pressed at that temperature.

9. The non-woven fabric composite material of claim 1, wherein the coir fiber and the fiber made from the synthetic thermoplastic polymer are pressed at a compression pressure ranging from 25 psi to 400 psi.

10. A method of preparing a non-woven fabric composite material comprising:
obtaining coir fiber;
milling the coir fiber to a desired fiber length;
mixing the milled coir fiber with a fiber made from or including a synthetic thermoplastic polymer, wherein the synthetic thermoplastic polymer is selected from the group consisting of polypropylene, polyethylene, polylactic acid, and mixtures thereof, and wherein the fiber made from the synthetic thermoplastic polymer has a lower viscous flow temperature than the degradation temperature of the coir fiber;
creating a matted material from the blended fibers using carding and needle punching, air deposition of fibers sprayed with a light glue, or other processes, to give a matted non-woven fabric composite material;
heating the matted material to a temperature throughout the matted material that is higher than the melt temperature of the fiber made from or including the synthetic thermoplastic polymer; and
pressing the heated matted material while at that temperature at a compression pressure range of 25 psi or more.

11. The method of claim 10, wherein the coir fiber is stripped of its waxy coating and the coir fiber or the fiber made from the synthetic thermoplastic polymer is treated with a chemical compatibilizer to yield a graft copolymer.

12. The method of claim 10, further comprising pressing the heated matted material using a die in a compression molding machine to become a shaped rigid part.

13. The method of claim 10, wherein the fiber made from the synthetic thermoplastic polymer comprises polypropylene and further comprising heating the matted material to a temperature above 180° C. and lower than the degradation temperature of the coir fiber and pressing the heated matted material at that temperature.

14. The method of claim 10, wherein the fiber made from the synthetic thermoplastic polymer comprises polypropylene and further comprising heating the matted material to a temperature above 180° C. and lower than 240° C.

15. The method of claim 10, further comprising heating the matted material to a temperature between 200° C. and 230° C. and pressing the heated matted material at that temperature.

16. The method of claim 10, further comprising pressing the heating matted material at a compression pressure range of 25 psi to 400 psi.
